(19) United States
(12) Patent Application Publication
(10) Pub. No.: US 2026/0118163 A1
(43) Pub. Date: Apr. 30, 2026

(54) DETECTION DEVICE

(71) Applicant: Magnolia White Corporation, Tokyo (JP)

(72) Inventor: Shinya ASAKURA, Tokyo (JP)

(21) Appl. No.: 19/431,515

(22) Filed: Dec. 23, 2025

Related U.S. Application Data
(63) Continuation of application No. PCT/JP2024/018076, filed on May 16, 2024.

(30) Foreign Application Priority Data
Jul. 3, 2023 (JP) 2023-109576

(51) Int. Cl. G01J 1/02; G01J 1/04; G01J 1/08

(52) U.S. Cl. CPC G01J 1/0228; G01J 1/0429; G01J 1/044; G01J 1/08

(57) ABSTRACT

According to an aspect, a detection device includes: a light source device including light-emitting elements arranged in a planar configuration; a light-transmitting placement substrate on which an object to be detected is to be placed; an electronic shutter having divided areas; and an optical sensor having detection areas arranged in a planar configuration. Each of the detection areas includes one or more photodetection elements. The divided areas in the electronic shutter are switchable between a light-transmitting state and a non-light-transmitting state for each of the divided areas, and the light-emitting elements are switchable between on and off for each of the light-emitting elements. Each of the light-emitting elements, one of the divided areas of the electronic shutter corresponding to the light-emitting element, and one of the detection areas corresponding to the light-emitting element overlap one another, as viewed from the first direction.

### CROSS-REFERENCE TO RELATED APPLICATION

This application claims the benefit of priority from Japanese Patent Application No. 2023-109576 filed on Jul. 3, 2023 and International Patent Application No. PCT/JP2024/018076 filed on May 16, 2024, the entire contents of which are incorporated herein by reference.

### BACKGROUND

### 1. Technical Field

What is disclosed herein relates to a detection device.

### 2. Description of the Related Art

Japanese Patent Application Laid-open Publication No. 2018-033430 (JP-A-2018-033430) discloses a biosensor that includes an optical sensor including a photosensor (photodetection element), a culture vessel placed on the upper side of an imaging surface of the photosensor, and a light-emitting element disposed above the culture vessel. In the biosensor of JP-A-2018-033430, light emitted from the light-emitting element passes through a culture medium and a plurality of objects to be detected (microorganisms) in the culture vessel, and enters the photosensor.

When a plurality of the light-emitting elements are arranged in such a detection device, a single object to be detected is irradiated with light in different directions from the light-emitting elements, potentially resulting in blurring of an image captured by the optical sensor.

For the foregoing reasons, there is a need for a detection device capable of improving accuracy of detection.

### SUMMARY

According to an aspect, a detection device includes: a light source device including a plurality of light-emitting elements arranged in a planar configuration; a light-transmitting placement substrate that is disposed on one side in a first direction of the light source device so as to overlap the light source device, and on which an object to be detected is to be placed; an electronic shutter that is disposed on one side in the first direction of the placement substrate so as to overlap the placement substrate, and has a plurality of divided areas arranged in a planar configuration; and an optical sensor that is disposed on one side in the first direction of the electronic shutter so as to overlap the electronic shutter, and has a plurality of detection areas arranged in a planar configuration. Each of the detection areas includes one or more photodetection elements. The divided areas in the electronic shutter are switchable between a light-transmitting state and a non-light-transmitting state for each of the divided areas, and the light-emitting elements are switchable between on and off for each of the light-emitting elements. Each of the light-emitting elements, one of the divided areas of the electronic shutter corresponding to the light-emitting element, and one of the detection areas corresponding to the light-emitting element overlap one another, as viewed from the first direction.

### BRIEF DESCRIPTION OF THE DRAWINGS

FIG. 1 is a perspective view schematically illustrating a detection device according to an embodiment of the present disclosure;

FIG. 2 is a perspective view illustrating a state in which a top panel has been removed from FIG. 1;

FIG. 3 is a schematic view of the detection device according to the embodiment;

FIG. 4 is a schematic view of a dimming panel (liquid crystal panel) serving as an electronic shutter;

FIG. 5 is a block diagram illustrating a configuration example of the detection device;

FIG. 6 is a schematic view illustrating projection areas of light emitted from light-emitting elements;

FIG. 7 is a schematic view of the detection device according to the embodiment;

FIG. 8 is a schematic plan view of a light source device according to the embodiment;

FIG. 9 is a schematic plan view of the electronic shutter according to the embodiment;

FIG. 10 is a schematic plan view of an optical sensor according to the embodiment;

FIG. 11 is a flowchart illustrating an exemplary detection operation of the detection device according to the embodiment;

FIG. 12 is a schematic view illustrating an order in which the light-emitting elements are turned on;

FIG. 13 is a schematic view illustrating an order in which the electronic shutter opens; and

FIG. 14 is a schematic view illustrating an order in which photodetection elements of the detection device perform detection.

### DETAILED DESCRIPTION

The following describes a mode (embodiment) for carrying out the present disclosure in detail with reference to the drawings. The present disclosure is not limited to the description of the embodiment given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure.

To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In XYZ coordinates in the drawings, a Z direction (first direction) corresponds to the up-down direction; an X direction (second direction) corresponds to the left-right direction; and a Y direction (third direction) corresponds to the front-rear direction. The X direction intersects (at right angles) the Y and Z directions; the Y direction intersects (at right angles) the X and Z directions; and the Z direction intersects (at right angles) the X and Y directions. A Z1 side is one side in the first direction, and a Z2 side is the other side in the first direction. The term “plan view” refers to a state viewed from the Z direction (first direction).

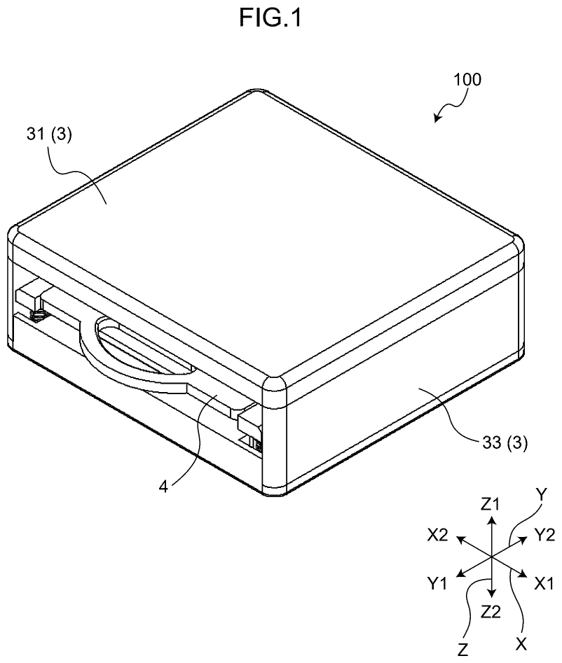

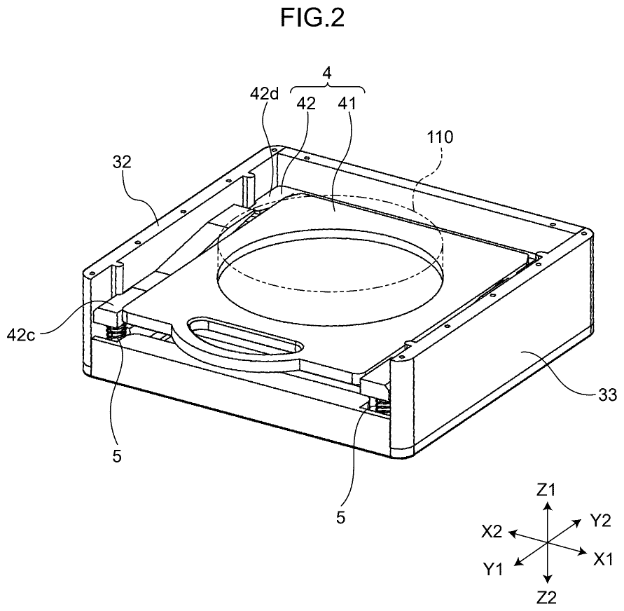

FIG. 1 is a perspective view schematically illustrating a detection device according to the embodiment. FIG. 2 is a perspective view illustrating a state in which a top panel has been removed from FIG. 1.

As illustrated in FIGS. 1 and 2, a detection device 100 has a substantially box shape. The detection device 100 includes a housing 3 and a holding member 4. The housing 3 includes a top panel 31 and side panels 32 and 33. The holding member 4 includes a plate 41 and a base plate 42. A container 110 is placed on the plate 41. Four corners of the base plate 42 are provided with a front holder 42c and a rear holder 42d. The front and rear holders 42c and 42d are urged upward (toward the Z1 side) by springs 5. Since the container 110 is placed on the plate 41, the plate 41 and the container 110 are urged upward (toward the Z1 side) by the springs 5.

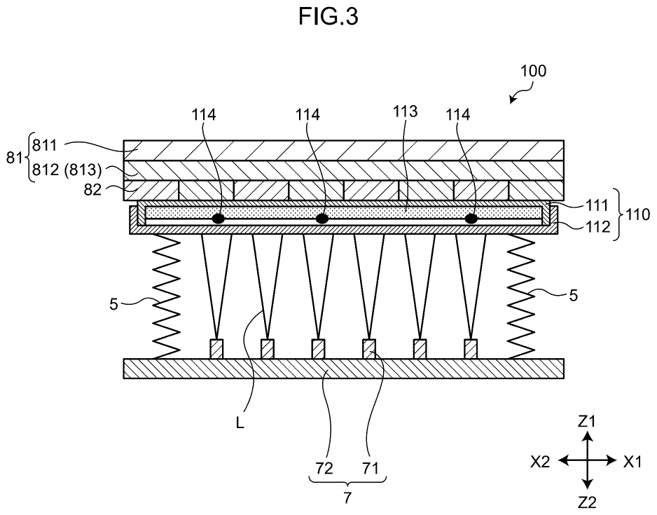

FIG. 3 is a schematic view of the detection device according to the embodiment. As illustrated in FIG. 3, the detection device 100 includes a light source device 7, the container 110, an electronic shutter 82, an optical sensor 81, and the springs 5.

The light source device 7 includes a light source board 72 and a plurality of light-emitting elements 71. The light-emitting elements 71 are light-emitting diodes (LEDs), for example. Thus, the light source device 7 includes the light-emitting elements 71 arranged in a planar configuration.

The container 110 includes a placement substrate 111 and a cover member 112. The container 110 is a Petri dish, for example. The container 110 has a light-transmitting property. The placement substrate 111 is a light-transmitting substrate that is disposed on the Z1 side of the light source device 7 so as to overlap the light source device 7, and on which an object to be detected 114 is placed.

In the present embodiment, the container 110 is placed upside down with respect to a normal container. That is, in the normal container, the placement substrate is located on the lower side and the cover member is located on the upper side. In contrast, in the container 110 according to the present embodiment, the placement substrate 111 is located on the upper side, while the cover member 112 is located on the lower side. In addition, the optical sensor 81 and the electronic shutter 82 are provided on the upper side (Z1 side) of the upside-down container 110, while the light source device 7 is provided on the lower side (Z2 side) of the upside-down container 110. A culture medium 113 (e.g., agar) is provided on the lower side of the placement substrate 111, and the object to be detected 114 is applied onto the culture medium 113 (surface on the lower side of the culture medium 113). The object to be detected 114 is, for example, microorganisms such as bacteria, or a sample containing the microorganisms, and forms colonies over time on the culture medium 113. The object to be detected 114 is not limited to the bacteria and may be other micro-objects such as cells.

The optical sensor 81 includes an array substrate 811 and a sensor pixel 812 (photodetection element 813, or photodiode). The optical sensor 81 is located on the Z1 side with respect to the electronic shutter 82 so as to overlap the electronic shutter 82. A plurality of the sensor pixels 812 are provided on a surface on the Z2 side of the array substrate 811. The electronic shutter 82 will be discussed later.

Light L emitted from the light-emitting elements 71 passes through the cover member 112, the culture medium 113, the placement substrate 111, and divided areas placed in a light-transmitting state (open state) of the electronic shutter 82, and is emitted toward the optical sensor 81. The intensity of light received by the photodetection elements 813 (photodiodes) of the optical sensor 81 differs between an area overlapping the object to be detected 114 and an area not overlapping the object to be detected 114. As a result, the optical sensor 81 can image the object to be detected 114. Thus, the detection device 100 is a device for monitoring changes in the object to be detected 114 by placing the object to be detected 114 contained in the container 110, between the light source device 7 and the optical sensor 81, and imaging the object to be detected 114 using the optical sensor 81.

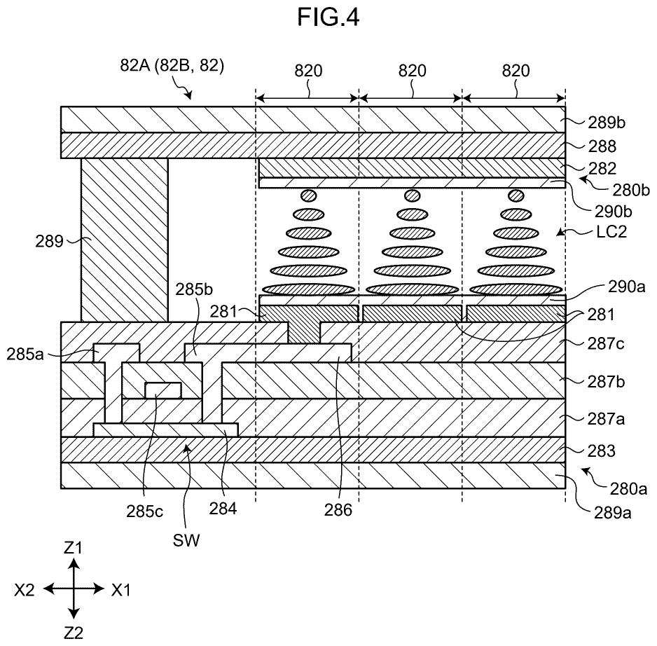

FIG. 4 is a schematic view of a dimming panel (liquid crystal panel) serving as the electronic shutter. In the present embodiment, a dimming panel 82A (light control panel) serves as electronic shutter 82. In the embodiment, the dimming panel 82A is a liquid crystal panel 82B. That is, the electronic shutter 82 according to the present embodiment is the liquid crystal panel 82B. The electronic shutter 82 can transmit or block light using a polarizer on a light-emitting side of a liquid crystal layer LC2 by controlling the twisted state of liquid crystal molecules by turning on or off the voltage applied to electrodes. FIG. 4 illustrates three divided areas 820 divided in the X direction.

The dimming panel 82A includes a first substrate 280a, a second substrate 280b, and the liquid crystal layer LC2. Specifically, the second substrate 280b is located with a gap interposed between itself and the Z1 side of the first substrate 280a, and the liquid crystal layer LC2 is provided between the second substrate 280b and the first substrate 280a.

The first substrate 280a includes a first polarizer 289a, a first transparent substrate 283, an insulating layer 287a, an insulating layer 287b, an insulating layer 287c, a first electrode 281, and a first orientation film 290a. Specifically, the first polarizer 289a, the first transparent substrate 283, the insulating layer 287a, the insulating layer 287b, the insulating layer 287c, the first electrode 281, and the first orientation film 290a are stacked in this order from the Z2 side toward the Z1 side.

The second substrate 280b includes a second polarizer 289b, a second transparent substrate 288, a second electrode 282, and a second orientation film 290b. Specifically, the second polarizer 289b, the second transparent substrate 288, the second electrode 282, and the second orientation film 290b are stacked in this order from the Z1 side toward the Z2 side.

The first polarizer 289a and the second polarizer 289b are polarizers that each transmit components of incident light that vibrate in a predetermined direction and block components of the light that vibrate in directions other than that direction.

The first transparent substrate 283 and the second transparent substrate 288 are glass substrates, for example. The first electrode 281 and the second electrode 282 are light-transmitting electrodes using indium tin oxide (ITO) or the like, for example. The first orientation film 290a and the second orientation film 290b are made of polyimide (PI), for example. The orientation films are each provided to control the orientation of the liquid crystal molecules when the liquid crystal molecules are required to be aligned in one direction over a certain degree of wide area.

The dimming panel 82A includes a switch SW configured with a thin-film transistor (TFT), for example. The switch SW includes a channel 284, a source 285a, a drain 285b, and a gate 285c provided on the first transparent substrate 283 of the first substrate 280a. The source 285a is supplied with a potential based on a local dimming signal. The drain 285b is electrically coupled to wiring 286. The switch SW switches between a state in which a drain current flows to the first electrode 281 and a state in which the drain current does not, depending on presence or absence of a signal to the gate 285c. The first electrode 281, the second electrode 282, and one switch SW are provided for each of the divided areas 820.

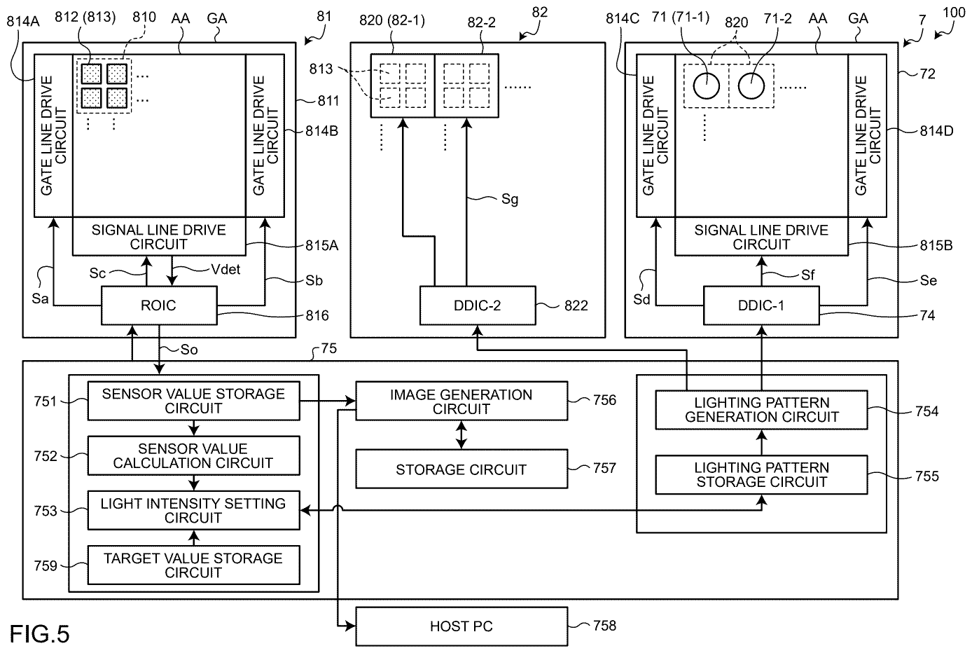

FIG. 5 is a block diagram illustrating a configuration example of the detection device. As illustrated in FIG. 5, the detection device 100 includes a host integrated circuit (IC) 75 that controls the optical sensor 81, the electronic shutter 82, and the light source device 7. The optical sensor 81 includes the array substrate 811, the sensor pixels 812 (photodetection elements 813, or photodiodes) formed on the array substrate 811, gate line drive circuits 814A and 814B, a signal line drive circuit 815A, and a detection control circuit (ROIC) 816.

The array substrate 811 is formed using a substrate 21 as a base. Each of the sensor pixels 812 is configured with a corresponding one of the photodetection elements 813, a plurality of transistors, and various types of wiring.

The array substrate 811 has a detection area AA and a peripheral area GA. The detection area AA is an area provided with the sensor pixels 812 (photodetection elements 813). The peripheral area GA is an area between the outer perimeter of the detection area AA and the outer edges of the array substrate 811, and is an area not provided with the sensor pixels 812. The gate line drive circuits 814A and 814B, a signal line drive circuit 815A, and the detection control circuit 816 are provided in the peripheral area GA.

Each of the sensor pixels 812 is an optical sensor that includes the photodetection element (photodiode) 813 as a sensor element. Each of the photodetection elements 813 outputs an electrical signal corresponding to light emitted thereto.

The detection control circuit 816 is a circuit that supplies control signals Sa, Sb, and Sc to the gate line drive circuits 814A and 814B and the signal line drive circuit 815A, respectively, to control operations of these circuits. The detection control circuit 816 includes a signal processing circuit that processes detection signals Vdet from the photodetection elements 813.

The detection control circuit 816 processes the detection signals Vdet from the photodetection elements 813, and outputs sensor values So based on the detection signals Vdet to the host IC 75. Through this operation, the detection device 100 detects information on the object to be detected 114.

The electronic shutter 82 includes the divided areas 820 and a second light-emitting element control circuit (DDIC-2) 822. Each of the divided areas 820 is located so as to overlap a plurality (for example, four) of the photodetection elements 813. The second light-emitting element control circuit 822 is a circuit that supplies a control signal Sg to each of the divided areas 820 to control operations of these areas.

The light source device 7 includes the light source board 72, the light-emitting elements 71 formed on the light source board 72, gate line drive circuits 814C and 814D, a signal line drive circuit 815B, and a first light-emitting element control circuit (DDIC-1) 74.

The light-emitting elements 71 are arranged in a matrix having a row-column configuration in an area of the light source board 72 overlapping the detection area AA. The light source board 72 is a drive circuit board that drives each of the light-emitting elements 71 to be switched between on (lit state) and off (unlit state). Each of the light-emitting elements 71 is located to overlap a corresponding one of the divided areas 820 of the electronic shutter 82.

The first light-emitting element control circuit 74 is a circuit that supplies control signals Sd, Se, and Sf to the gate line drive circuits 814C and 814D, and the signal line drive circuit 815B, respectively, to control operations of these circuits.

The host IC 75 includes, as a control circuit for the optical sensor 81, a sensor value storage circuit 751, a sensor value calculation circuit 752, a light intensity setting circuit 753, and a target value storage circuit 759. The sensor value storage circuit 751 stores therein the sensor values So output from the detection control circuit 816 of the optical sensor 81. The sensor value calculation circuit 752 performs a predetermined calculation process on the sensor values So of the photodetection elements 813.

In a light intensity setting mode, the light intensity setting circuit 753 compares the sensor values So detected by the photodetection elements 813 with a preset target sensor value So-t acquired from the target value storage circuit 759 to set light intensities of the light-emitting elements 71 for detection. The target value storage circuit 759 stores therein the preset target sensor value So-t.

The host IC 75 includes, as a control circuit for the light source device 7, a lighting pattern generation circuit 754 and a lighting pattern storage circuit 755. The lighting pattern storage circuit 755 stores therein information on the light intensity of each of the light-emitting elements 71 in the light intensity setting mode.

The lighting pattern generation circuit 754 generates various control signals based on the information on the light intensity in the lighting pattern storage circuit 755.

The host IC 75 includes an image generation circuit 756 and a storage circuit 757. In a detection mode, the image generation circuit 756 generates an image of the object to be detected 114, based on the sensor values So output from the photodetection elements 813. The storage circuit 757 stores therein image data generated by the image generation circuit 756. The host IC 75 is coupled to a host personal computer (PC) 758 and transfers the image data to the host PC 758.

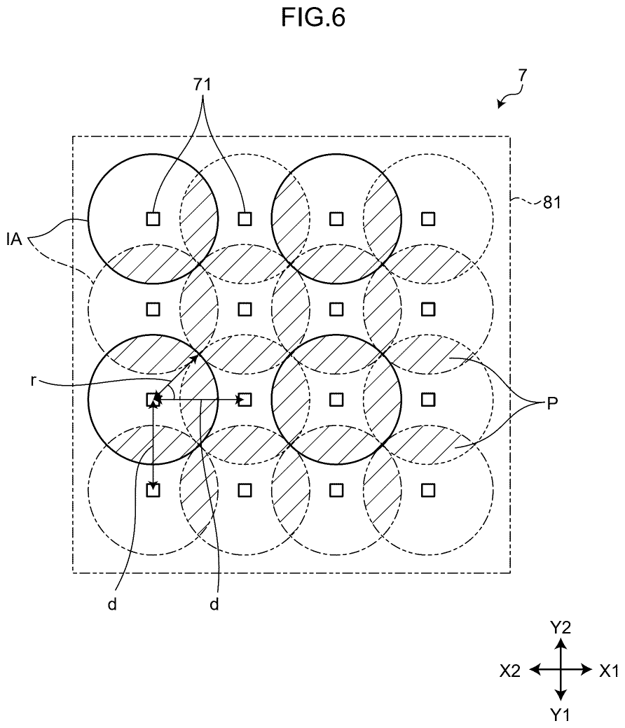

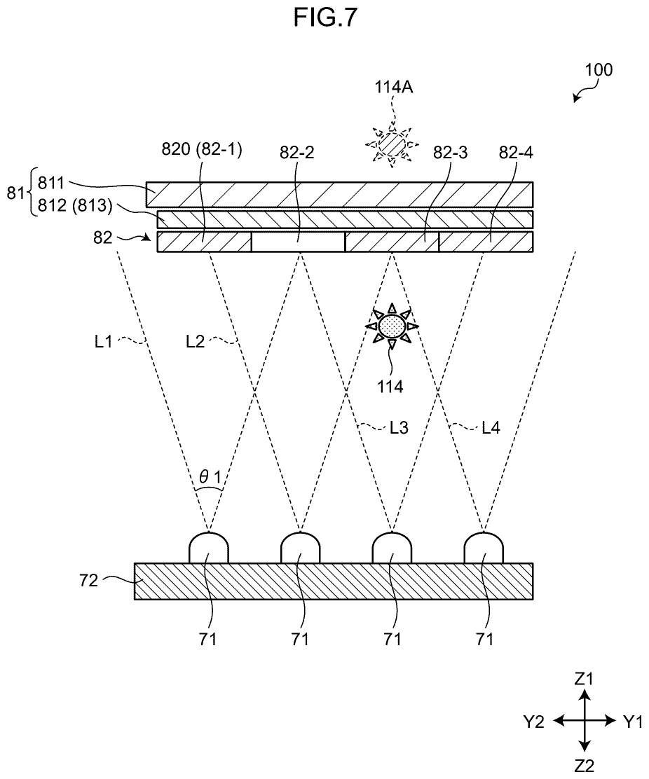

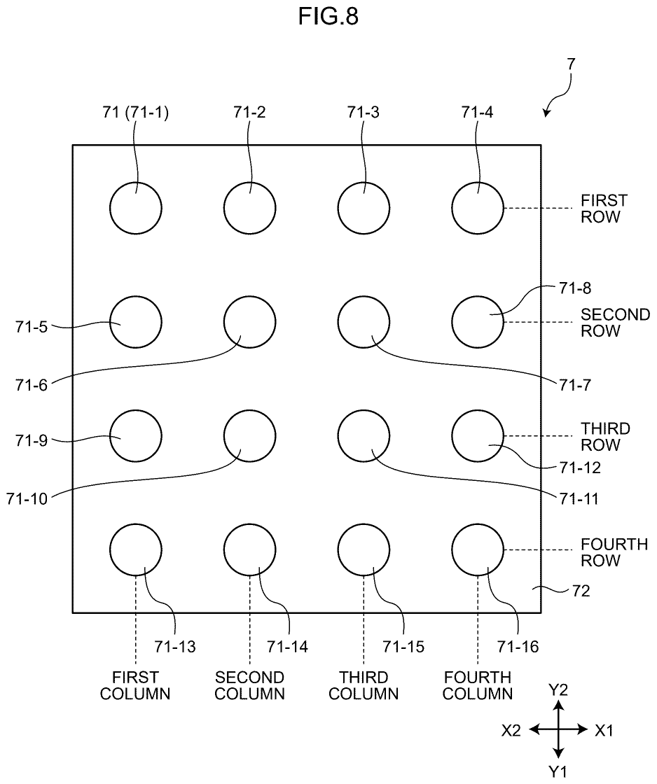

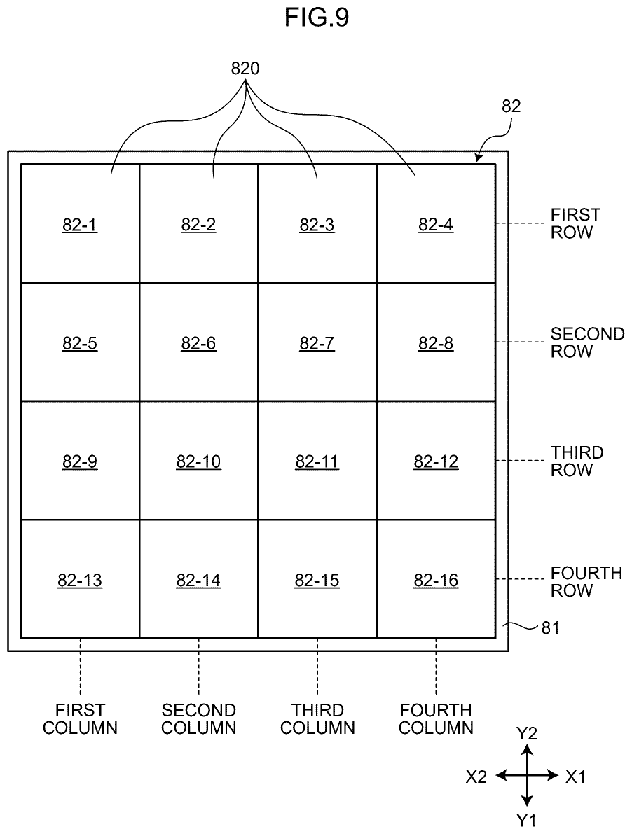

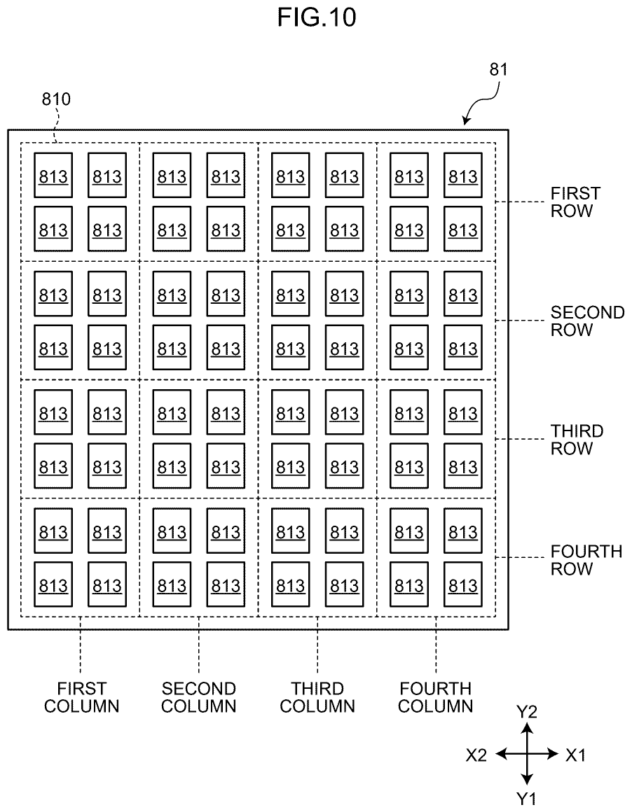

FIG. 6 is a schematic view illustrating projection areas of the light emitted from light-emitting elements. FIG. 7 is a schematic view of the detection device according to the embodiment. FIG. 8 is a schematic plan view of the light source device according to the embodiment. FIG. 9 is a schematic plan view of the electronic shutter according to the embodiment. FIG. 10 is a schematic plan view of the optical sensor according to the embodiment.

As illustrated in FIG. 6, a total of 16 light-emitting elements 71 according to the present embodiment are provided. The 16 light-emitting elements 71 are arranged in the X and Y directions in a matrix having a row-column configuration. Among these 16 light-emitting elements 71, the distance between the light-emitting elements 71 adjacent in the X direction is a distance d, and the distance between the light-emitting elements 71 adjacent in the Y direction is also the distance d.

As illustrated in FIG. 7, the light emitted from each of the light-emitting elements 71 radially spreads as it travels upward (toward the Z1 side). As a result, a projection area IA of light projected onto the optical sensor 81 without the electronic shutter 82 forms a circle having a radius r centered on the light-emitting element 71, as illustrated in FIG. 6. The projection areas IA adjacent in the X or Y direction have an overlapping portion P indicated by hatching. This overlapping portion P makes the image of the object to be detected 114 blurry or hazy.

As illustrated in FIG. 8, a total of 16 light-emitting elements 71 according to the present embodiment are provided. The light-emitting elements 71 are lit individually, one element at a time. That is, for example, during a unit period when one light-emitting element 71-1 is lit, the light-emitting elements 71 other than the light-emitting element 71-1 are in an unlit state. In other words, each of the light-emitting elements 71 is switchable between on and off individually.

The 16 light-emitting elements 71 are arranged at even intervals in the X and Y directions in a matrix having a row-column configuration, as described above. Specifically, four rows extending along the X direction are arranged, and four columns extending along the Y direction are arranged. As for the rows, for example, the first row is located on the most Y2 side. In the first row, four of the light-emitting elements 71 are arranged at even intervals from the X2 side toward the X1 side. Specifically, light-emitting elements 71-1, 71-2, 71-3, and 71-4 are arranged from the X2 side toward the X1 side. In the second row, four of the light-emitting elements 71 are arranged at even intervals from the X2 side toward the X1 side. Specifically, light-emitting elements 71-5, 71-6, 71-7, and 71-8 are arranged from the X2 side toward the X1 side. In the third row, four of the light-emitting elements 71 are arranged at even intervals from the X2 side toward the X1 side. Specifically, light-emitting elements 71-9, 71-10, 71-11, and 71-12 are arranged from the X2 side toward the X1 side. In the fourth row, four of the light-emitting elements 71 are arranged at even intervals from the X2 side toward the X1 side. Specifically, light-emitting elements 71-13, 71-14, 71-15, and 71-16 are arranged from the X2 side toward the X1 side.

As for the columns, for example, the first column is located on the most X2 side. In the first column, four of the light-emitting elements 71 are arranged at even intervals from the Y2 side toward the Y1 side. In the same way, in each of the second, third, and fourth columns, four of the light-emitting elements 71 are arranged at even intervals from the Y2 side toward the Y1 side.

As illustrated in FIG. 9, the electronic shutter 82 according to the present embodiment is divided into a total of 16 pieces in plan view as viewed from the Z direction. That is, the electronic shutter 82 has 16 divided areas 820 that are divided in the X and Y directions.

The divided areas 820 are brought into the light-transmitting state one by one. In other words, one divided area 820 that overlaps one lit light-emitting element 71 as viewed from the Z direction is brought into the light-transmitting state, and the divided areas 820 other than the one divided area 820 are brought into the non-light-transmitting state. That is, the divided areas 820 in the electronic shutter 82 can be switched between the light-transmitting state and the non-light-transmitting state individually. During a period when one of the divided areas 820 is in the light-transmitting state, the other divided areas 820 are closed. In other words, the period during which one of the divided areas 820 is in the light-transmitting state differs from the periods during which the others of the divided areas 820 are in the light-transmitting state.

The divided areas 820 adjacent to each other in the X or Y direction are arranged without a gap or with a slight gap interposed therebetween. Each of all the divided areas 820 has a square shape, as viewed from the Z direction. The divided areas 820 are arranged at even intervals in the X and Y directions in a matrix having a row-column configuration, as viewed from the Z direction. The 16 divided areas 820 are arranged at even intervals in the X and Y directions in a grid pattern. Specifically, in the same way as the arrangement of the light-emitting elements, four rows extending along the X direction are arranged, and four columns extending along the Y direction are arranged. As for the rows, for example, the first row is located on the most Y2 side. In the first row, four of the divided areas 820 are arranged at even intervals from the X2 side toward the X1 side. Specifically, divided areas 82-1, 82-2, 82-3, and 82-4 are arranged from the X2 side toward the X1 side. In the second row, four of the divided areas 820 are arranged at even intervals from the X2 side toward the X1 side. Specifically, divided areas 82-5, 82-6, 82-7, and 82-8 are arranged from the X2 side toward the X1 side. In the third row, four of the divided areas 820 are arranged at even intervals from the X2 side toward the X1 side. Specifically, divided areas 82-9, 82-10, 82-11, and 82-12 are arranged from the X2 side toward the X1 side. In the fourth row, four of the divided areas 820 are arranged at even intervals from the X2 side toward the X1 side. Specifically, divided areas 82-13, 82-14, 82-15, and 82-16 are arranged from the X2 side toward the X1 side.

As for the columns, for example, the first column is located on the most X2 side. In the first column, four of the divided areas 820 are arranged at even intervals from the Y2 side toward the Y1 side. In the same way, in each of the second, third, and fourth columns, four of the divided areas 820 are arranged at even intervals from the Y2 side toward the Y1 side.

In the present disclosure, the divided area 820 is not limited to the square shape in plan view. Thus, the divided area 820 may be, for example, an equilateral triangle, or a polygon having five or more vertices, in plan view.

As illustrated in FIG. 10, the optical sensor 81 has a plurality of detection areas 810. One detection area 810 includes one or more photodetection elements 813 (photodiodes). In the present embodiment, one detection area 810 includes four photodetection elements 813, but the present disclosure is not limited to this configuration, and the number of the photodetection elements 813 may be three or less, or five or more. The detection areas 810 are arranged correspondingly to the divided areas 820 of the electronic shutter 82. Specifically, the outline of the detection area 810 overlaps the outline of the divided area 820 of the electronic shutter 82. Thus, as viewed from the Z direction, the four photodetection elements 813 are arranged so as to overlap the divided area 820 of one electronic shutter.

The detection areas 810 are arranged at even intervals in the X and Y directions in a matrix having a row-column configuration, as viewed from the Z direction. Sixteen of the detection areas 810 are arranged at even intervals in the X and Y directions in a grid pattern. Specifically, in the same way as the arrangements of the light-emitting elements 71 and the divided areas 820 of the electronic shutter 82, four rows extending along the X direction are arranged, and four columns extending along the Y direction are arranged. As for the rows, for example, the first row is located on the most Y2 side. In the first row, four of the detection areas 810 are arranged at even intervals from the X2 side toward the X1 side. In the second row, four of the detection areas 810 are arranged at even intervals from the X2 side toward the X1 side. In the third row, four of the detection areas 810 are arranged at even intervals from the X2 side toward the X1 side. In the fourth row, four of the detection areas 810 are arranged at even intervals from the X2 side toward the X1 side.

Referring back to FIG. 5, the light-emitting element 71 overlaps the divided area 820 of the electronic shutter 82 as viewed from the Z direction. The divided area 820 of the electronic shutter 82 overlaps the photodetection element 813 as viewed from the Z direction. Thus, each of the light-emitting elements 71, a corresponding one of the divided areas 820 of the electronic shutter 82, and a corresponding one of the detection areas 810 overlap one another, as viewed from the Z direction. In the present embodiment, two or more of the light-emitting elements 71 may overlap one of the divided areas 820 of the electronic shutter 82. The light-emitting element 71 is configured with a light-emitting diode (LED), for example.

Also, in FIG. 7, as viewed from the Z direction, the divided area 82-1 overlaps the light-emitting element 71; the divided area 82-2 overlaps the light-emitting element 71; the divided area 82-3 overlaps the light-emitting element 71; and the divided area 82-4 overlaps the light-emitting element 71. Light L1 emitted from the light-emitting element 71-1 irradiates the entire area of the divided area 82-1 and a portion of the divided area 82-2. In the same way, light L2 irradiates the entire area of the divided area 82-2, a portion of the divided area 82-1, and a portion of the divided area 82-3. Light L3 irradiates the entire area of the divided area 82-3, a portion of the divided area 82-2, and a portion of the divided area 82-4. Light L4 irradiates the entire area of the divided area 82-4, a portion of the divided area 82-3, and a portion of the divided area 82-1. The irradiation angle of the light emitted from the light-emitting element 71 is an angle θ1, and 114A represents a captured image of the object to be detected.

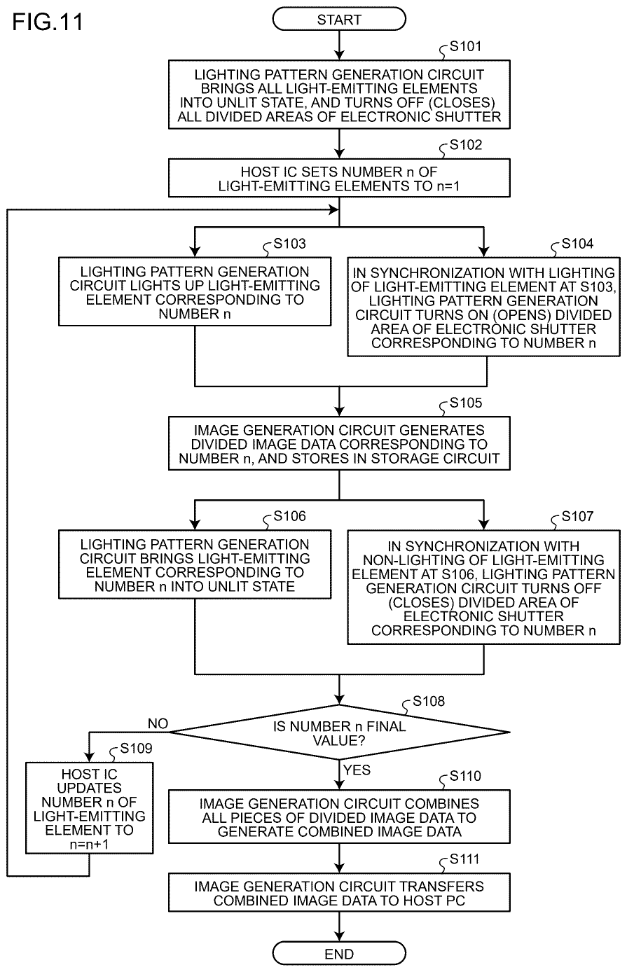

The following describes an exemplary detection operation of the detection device. FIG. 11 is a flowchart illustrating the exemplary detection operation of the detection device according to the embodiment.

First, the lighting pattern generation circuit 754 (refer to FIG. 5) brings all the light-emitting elements 71 into the unlit state, and brings all the divided areas 820 of the electronic shutter 82 into an off state (closed state) (Step S101). As a result, all the 16 light-emitting elements 71 illustrated in FIG. 8 are brought into the unlit state, and all the 16 divided areas 820 illustrated in FIG. 9 are brought into the off state.

The host IC 75 (refer to FIG. 5) then sets a number n (count value) of the light-emitting elements 71 to n=1 (Step S102).

The lighting pattern generation circuit 754 brings the light-emitting element 71 corresponding to the number n into the lit state (Step S103). Specifically, the light-emitting element 71-1 illustrated in FIG. 8 is brought into the lit state.

Then, in synchronization with the lighting of light-emitting element 71-1 at Step S103, the lighting pattern generation circuit 754 brings the divided area 820 of the electronic shutter 82 corresponding to the number n into an on state (open state) (Step S104). Specifically, the divided area 82-1 illustrated in FIG. 9 is brought into the on state.

The image generation circuit 756 (refer to FIG. 5) generates divided image data corresponding to the number n, and stores the generated data in the storage circuit 757 (Step S105). Thus, the divided image data corresponding to the divided area 82-1 illustrated in FIG. 9 is generated and stored.

The lighting pattern generation circuit 754 brings the light-emitting element corresponding to the number n into the unlit state (Step S106). Specifically, the light-emitting element 71-1 illustrated in FIG. 8 is brought into the unlit state.

In synchronization with the non-lighting of the light-emitting element 71-1 at Step S106, the lighting pattern generation circuit 754 brings the divided area 820 of the electronic shutter 82 corresponding to the number n into the off state (closed state) (Step S107). Specifically, the divided area 82-1 illustrated in FIG. 9 is brought into the off state.

The host IC 75 determines whether the number n is the final value (Step S108), and if the number n is not the final value (No at Step S108), the host IC 75 updates the number n of the light-emitting element to n=n+1 (Step S109). For example, the number n is updated from n=1 to n=2, and the process return to Steps S103 and S104.

The processes are performed from Steps S103 and S104 to Steps S106 and S107; the number n is determined again whether being the final value (Step S108); and the processes are repeated until the number n becomes the final value.

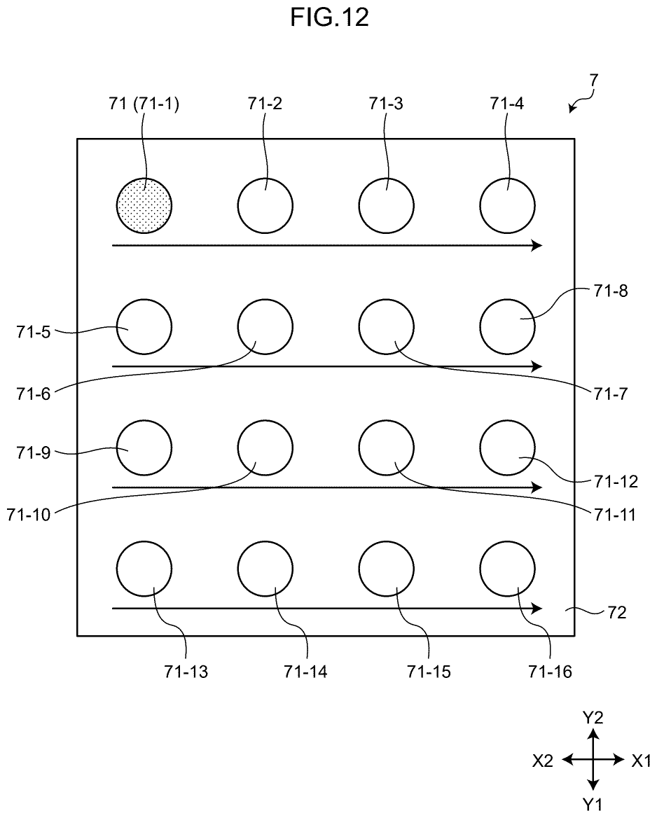

With reference to FIGS. 12, 13, and 14, the following specifically describes the order in which the light-emitting elements 71 are lit, the order in which the divided areas 820 of the electronic shutter 82 are brought into the light-transmitting state, and the order in which the photodetection elements 813 included in the detection areas 810 of the optical sensor 81 are detected.

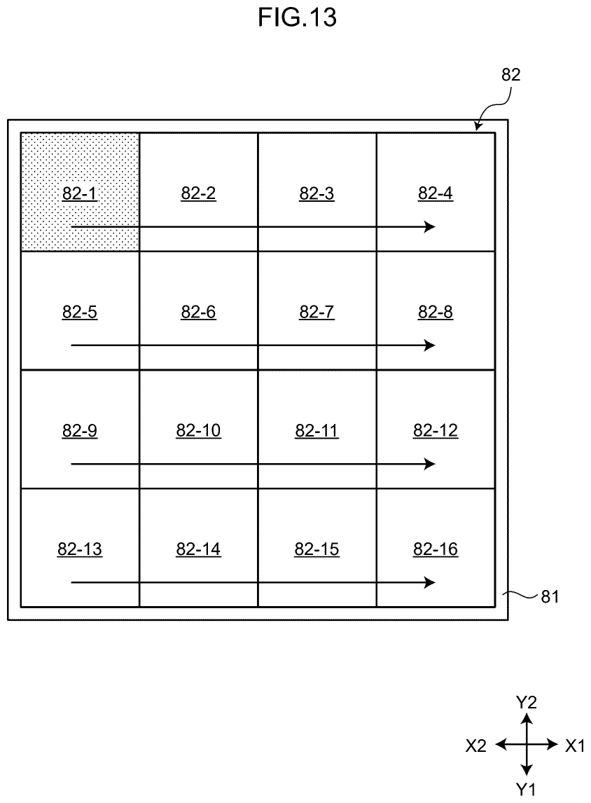

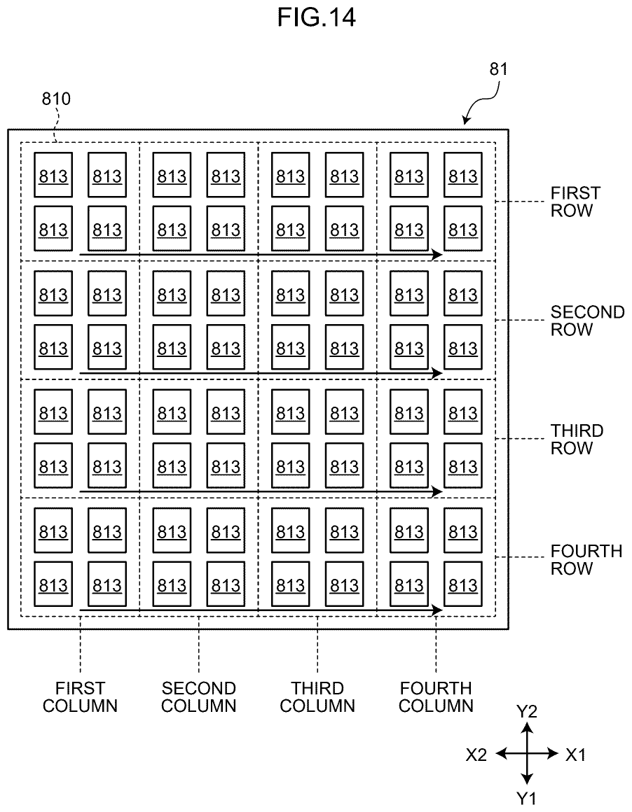

As illustrated in FIG. 12, as for the light-emitting elements 71, the light-emitting elements 71 in the first row are lit up one by one toward the X1 side. As illustrated in FIG. 13, as for the divided areas 820 of the electronic shutter 82, the divided areas 820 in the first row are brought into the light-transmitting state one by one toward the X1 side. As illustrated in FIG. 14, as for the photodetection elements 813, the detection areas 810 in the first row perform the detection sequentially such that the detection of one detection area 810 is performed at a time.

For example, when the light-emitting element 71-1 illustrated in FIG. 12 is lit up as indicated by dotted hatching, the divided area 82-1 of the electronic shutter 82 illustrated in FIG. 13 is brought into the light-transmitting state, and the detection is performed by four of photodetection elements 813 included in the detection area 810 in the first row and the first column illustrated in FIG. 14. Then, the light-emitting element 71-2 at a position shifted by one column toward the X1 side is lit up; the divided area 82-2 is brought into the light-transmitting state; and the detection is performed by one of the detection areas 810 overlapping the divided area 82-2. Subsequently, the lighting and the detection are performed one by one in the first row, and the operation then shifts to the second row. Specifically, the light-emitting element 71-5 in the second row and the first column is lit up; the divided area 82-5 is brought into the light-transmitting state; and the detection is performed by one of the detection areas 810 overlapping the divided area 82-5. Thereafter, the detection is also performed by the detection area 810 shifted one by one toward the X1 side. When the detection in the second row is completed, the same detection is repeated from the third row to the fourth row, and the last detection is performed by the detection area 810 located in the fourth row and the fourth column.

Referring back to the flowchart in FIG. 11, if the host IC 75 determines that the number n is the final value (Yes at Step S108), the image generation circuit 756 combines all pieces of the divided image data to generate combined image data (Step S110). Thus, the combined image data of all the areas illustrated in FIG. 14 is generated. The image generation circuit 756 transfers the combined image data to the host PC 758 (Step S111).

As described above, the detection device 100 includes the light source device 7, the light-transmitting placement substrate 111, the electronic shutter 82 having the divided areas 820, and the optical sensor 81 having the detection areas 810. One detection area 810 includes one or more photodetection elements 813. The divided areas 820 in the electronic shutter 82 can be switched between the light-transmitting state and the non-light-transmitting state for each of the divided areas 820, and the light-emitting elements 71 can be switched between on and off for each of the light-emitting elements 71. Each of the light-emitting elements 71, a corresponding one of the divided areas 820 of the electronic shutter 82, and a corresponding one of the detection areas 810 overlap one another, as viewed from the Z direction.

As described above, when the light-emitting elements 71 are arranged, the single object to be detected 114 is irradiated with light in different directions from the light-emitting elements 71, potentially resulting in blurring of the image captured by the optical sensor 81.

In contrast, in the present embodiment, each of the light-emitting elements 71, a corresponding one of the divided areas 820 of the electronic shutter 82, and a corresponding one of the detection areas 810 in the optical sensor 81 overlap one another, as viewed from the Z direction. Therefore, by turning on one light-emitting element 71 and bringing the divided area 820 of the electronic shutter 82 overlapping the one light-emitting element 71 into the light-transmitting state, a plurality of rays of light are inhibited from entering the detection area 810 of the optical sensor 81 overlapping the divided area 820 in the light-transmitting state. As a result, the blurring of the image captured by the optical sensor 81 can decrease.

The electronic shutter 82 is the liquid crystal panel 82B. Liquid crystal panels are widely used, and therefore, are easily available and low cost. Therefore, the processing steps required to manufacture the detection device 100 can be reduced, and costs can also be reduced.

During the unit period when one of the light-emitting elements 71 is lit, the light-emitting elements 71 other than the one light-emitting element 71 are brought into the unlit state; one of the divided areas 820 that overlaps the one light-emitting element 71 as viewed from the Z direction is brought into the light-transmitting state; and the divided areas 820 other than the one divided area 820 is brought into the non-light-transmitting state.

Thus, one of the light-emitting elements 71 can be lit up; only the divided area 820 of the electronic shutter 82 overlapping the one light-emitting element 71 can be brought into the light-transmitting state; and the divided areas 820 other than the one divided area 820 can be brought into the non-light-transmitting state. Therefore, the light L transmitted through the divided area 820 in the light-transmitting state is limited to the light L emitted from the one light-emitting element 71. As a result, the blurring of the image captured by the optical sensor 81 can further decrease.

The light-emitting elements 71, the divided areas 820, and the detection areas 810 are arranged along the X and Y directions in a matrix having a row-column configuration. When N is a natural number, the detection is sequentially performed by each of the photodetection elements 813 along the X direction using the light of the light-emitting elements 71 in the Nth row, and after the detection in the Nth row ends, the detection is sequentially performed along the X direction using the light of the light-emitting elements 71 in the (N+1)th row.

Thus, since the detection of the light L is sequentially performed by each of the detection areas 810, an image with higher detection accuracy can be obtained by combining the images detected in all the detection areas 810.

The present disclosure is not limited to the embodiment described above, and includes various aspects. For example, in the embodiment described above, when one of the light-emitting elements 71 is lit up, the divided area 820 overlapping this lit-up light-emitting element 71 is brought into the light-transmitting state. However, for example, during the unit period when a certain light-emitting element 71 (first light-emitting element) is lit up, the light-emitting elements 71 other than this light-emitting element 71 (first light-emitting element) may also be lit up; the divided areas 820 (first divided areas) overlapping these lit-up light-emitting elements 71 may be brought into the light-transmitting state; and the image may be captured by the optical sensor 81. However, to avoid a plurality of rays of the light L from entering each photodetection element 813 from around, the divided areas 820 (second divided areas) around the divided area 820 (first divided area) overlapping the lit-up light-emitting element 71 are brought into the non-light-transmitting state.

What is claimed is:

1. A detection device comprising:
a light source device comprising a plurality of light-emitting elements arranged in a planar configuration;
a light-transmitting placement substrate that is disposed on one side in a first direction of the light source device so as to overlap the light source device, and on which an object to be detected is to be placed;
an electronic shutter that is disposed on one side in the first direction of the placement substrate so as to overlap the placement substrate, and has a plurality of divided areas arranged in a planar configuration; and
an optical sensor that is disposed on one side in the first direction of the electronic shutter so as to overlap the electronic shutter, and has a plurality of detection areas arranged in a planar configuration, wherein
each of the detection areas comprises one or more photodetection elements,
the divided areas in the electronic shutter are switchable between a light-transmitting state and a non-light-transmitting state for each of the divided areas, and the light-emitting elements are switchable between on and off for each of the light-emitting elements, and
each of the light-emitting elements, one of the divided areas of the electronic shutter corresponding to the light-emitting element, and one of the detection areas corresponding to the light-emitting element overlap one another, as viewed from the first direction.

2. The detection device according to claim 1, wherein the electronic shutter is a liquid crystal panel.

3. The detection device according to claim 1, wherein during a unit period when a first light-emitting element of the light-emitting elements is lit, at least a light-emitting element that overlaps a second divided area located around a first divided area overlapping the first light-emitting element, as viewed from the first direction, is configured to be brought into an unlit state; the first divided area is configured to be brought into a light-transmitting state; and the second divided area is configured to be brought into a non-light-transmitting state.

4. The detection device according to claim 3, wherein
the light-emitting elements, the divided areas, and the detection areas are arranged in a matrix having a row-column configuration along both a second direction intersecting the first direction and a third direction intersecting the first direction and the second direction, and
when N is a natural number, detection is sequentially performed from one end to another end along the second direction by the photodetection elements arranged in an Nth row using light of each of the corresponding light-emitting elements one by one in sequence, and after the detection in the Nth row ends, the detection is sequentially performed from the one end to the other end along the second direction by the photodetection elements in the (N+1)th row using the light of each of the corresponding light-emitting elements one by one in sequence.

5. The detection device according to claim 2, wherein during a unit period when a first light-emitting element of the light-emitting elements is lit, at least a light-emitting element that overlaps a second divided area located around a first divided area overlapping the first light-emitting element, as viewed from the first direction, is configured to be brought into an unlit state; the first divided area is configured to be brought into a light-transmitting state; and the second divided area is configured to be brought into a non-light-transmitting state.

6. The detection device according to claim 5, wherein
the light-emitting elements, the divided areas, and the detection areas are arranged in a matrix having a row-column configuration along both a second direction intersecting the first direction and a third direction intersecting the first direction and the second direction, and
when N is a natural number, detection is sequentially performed from one end to another end along the second direction by the photodetection elements arranged in an Nth row using light of each of the corresponding light-emitting elements one by one in sequence, and after the detection in the Nth row ends, the detection is sequentially performed from the one end to the other end along the second direction by the photodetection elements in the (N+1)th row using the light of each of the corresponding light-emitting elements one by one in sequence.
